(19) United States
(12) Patent Application Publication
(10) Pub. No.: US 2026/0127592 A1
(43) Pub. Date: May 7, 2026

(54) REMITTANCE SYSTEM USING STABLECOIN

(71) Applicant: DATACHAIN, INC., Tokyo (JP)

(72) Inventors: Yusuke TAKEZAWA, Tokyo (JP); Tatsuya SAITO, Tokyo (JP); Tetsushi HISATA, Tokyo (JP)

(21) Appl. No.: 19/335,498

(22) Filed: Sep. 22, 2025

(30) Foreign Application Priority Data
Sep. 24, 2024 (JP) 2024-165223

(51) Int. Cl. G06Q 20/38

(52) U.S. Cl. CPC G06Q 20/389

(57) ABSTRACT

The remittance system is composed of an originating-side integration subsystem linked to an originating-side financial institution system of a remitter, a beneficiary-side integration subsystem linked to a beneficiary-side financial institution system of a recipient, a blockchain management subsystem linked to the originating-side integration subsystem and the beneficiary-side integration subsystem via the SWIFT system, and a plurality of blockchains linked to the blockchain management subsystem. The blockchain management subsystem and the originating-side integration subsystem send information relating to an SC transfer on the plurality of blockchains to the SWIFT system.

### TECHNICAL FIELD

The present invention relates to a remittance system that performs international remittances using stablecoins (SC). In further detail, the present invention relates to a remittance system that performs international remittances using SC by integration with the SWIFT system.

### BACKGROUND ART

A digital currency called SC is attracting attention. SC are coins issued on a blockchain, where the price of the coins are linked (pegged) to legal tender. SC are expected to be used in international remittances.

Currently, legal tender is mainly used in international remittances among countries. For smooth international remittances, the Society for Worldwide Interbank Financial Telecommunication (hereinafter referred to as “SWIFT”) provides a SWIFT system. The SWIFT system is a messaging system linking financial institution systems around the world. The SWIFT system does not perform actual remittances, but sends transaction orders between financial institutions using SWIFT codes.

Accompanying the transmission of a transaction order, a remittance is performed from an account of a remitter bank (i.e., originating bank) to an account of a recipient bank (i.e., beneficiary bank). In an international remittance, however, in a case where an originating bank and a beneficiary bank do not have an account with each other, a correspondent bank mediating the remittance is required.

Patent Literature 1 describes a fund management system in which remittances are performed using SC. This remittance management system comprises: a token issuing unit for issuing a token (that is a stablecoin pegged to legal tender) of a blockchain in accordance with an amount of funds entrusted by an entruster to a trustee; a token transfer processing unit for transferring, in accordance with a remittance of all or a part of the entrusted funds from the trustee, the token in an amount corresponding to the amount of remittance from a first account of the trustee in the blockchain to a second account of the recipient of the entrusted funds in the blockchain; a transaction information acquisition unit for acquiring transaction information indicating a transaction between financial institution accounts; and a verification processing unit for verifying a correspondence between the amount of the token transferred from the first account to the second account and the amount of funds remitted from the account of the trustee to the account of the recipient indicated by the transaction information (cf. claim 1).

### CITATION LIST

### Patent Literature

[Patent Literature 1] JP 6738113 B1 (WO 2021/234974 A1)

### SUMMARY OF INVENTION

### Technical Problem

International remittances using the SWIFT system have conventionally taken a long time when mediated by a correspondent bank.

International remittances by means of SC using the SWIFT system have not been performed, yet. As for the fund management system described in Patent Literature 1, it simply performs remittances using a blockchain, does not use the SWIFT system, and also does not take account of integration with the SWIFT system.

An object of the present invention is to provide a remittance system for performing an international remittance using SC by integration with the SWIFT system and not via a correspondent bank.

In addition, when an international remittance is performed using SC, there may be cases where a plurality of or different types of SC or underlying blockchains are used between an originating financial institution and a beneficiary financial institution. Currently, there is no system for remitting SC across a plurality of or different blockchains (i.e., performing a cross-chain transaction).

An object of the present invention is to provide a remittance system for performing an international remittance using SC across a plurality of blockchains while utilizing the SWIFT system.

### Solution to Problem

Aspects of the present invention are described below.

### ASPECT 1

A remittance system for performing an international remittance using stablecoins (SC) by integration with a SWIFT system linked to a financial institution system, the remittance system comprising:
an originating-side integration subsystem linked to an originating-side financial institution system of a remitter;
a beneficiary-side integration subsystem linked to a beneficiary-side financial institution system of a recipient;
a blockchain management subsystem linked to the originating-side integration subsystem and the beneficiary-side integration subsystem via the SWIFT system; and
a plurality of blockchains or a single blockchain linked to the blockchain management subsystem,
wherein the blockchain management subsystem and the originating-side integration subsystem are configured to transmit information relating to an SC transfer on the plurality of blockchains or the single blockchain to the SWIFT system.

### ASPECT 2

The remittance system described in Aspect 1,
in which the information relating to an SC transfer is information relating to a transaction (Tx) of SC.

### ASPECT 3

The remittance system described in Aspect 1,
in which the originating-side integration subsystem sends a remittance instruction to the blockchain management subsystem via the SWIFT system.

### ASPECT 4

The remittance system described in Aspect 3,
in which the remittance instruction is a transaction (Tx) signed by a private key of the originating-side integration subsystem or the blockchain management subsystem.

### ASPECT 5

The remittance system described in Aspect 1,
in which the plurality of blockchains comprise an originating-side blockchain and a beneficiary-side blockchain, and
in which the blockchain management subsystem, when receiving the remittance instruction from the originating-side integration subsystem via the SWIFT system, locks originating-side SC on the originating-side blockchain and unlocks beneficiary-side SC on the beneficiary-side blockchain.

### ASPECT 6

The remittance system described in Aspect 5,

in which due to locking of the originating-side SC, the originating-side SC are transferred on the originating-side blockchain from an originating-side account to a liquidity pool, and
in which due to unlocking of the beneficiary-side SC, the beneficiary-side SC are transferred on the beneficiary-side blockchain from the liquidity pool to a beneficiary-side account.

### ASPECT 7

The remittance system described in Aspect 6,
in which the blockchain management subsystem detects and verifies a packet for verifying the validity of a transaction or data relating to the lock of the originating-side SC on the originating-side blockchain, and detects and verifies a packet for verifying the validity of a transaction or data relating to the unlock of the beneficiary-side SC on the beneficiary-side blockchain.

### ASPECT 8

The remittance system described in Aspect 7,
in which the originating-side integration subsystem sends a request for acquiring a remittance status to the blockchain management subsystem via the SWIFT system.

### ASPECT 9

The remittance system described in Aspect 8,
in which the blockchain management subsystem, when receiving the request for acquiring a remittance status, sends the remittance status based on the approval of the lock of the originating-side SC and the approval of the unlock of the beneficiary-side SC to the originating-side integration subsystem via the SWIFT system.

### ASPECT 10

The remittance system described in Aspect 1,
in which the originating-side integration subsystem sends via the SWIFT system the completion of the SC remittance to the beneficiary-side integration subsystem.

### ASPECT 11

The remittance system described in Aspect 1,
in which the plurality of blockchains comprise an originating-side blockchain and a beneficiary-side blockchain,
in which the blockchain management subsystem includes a gas fee manager that processes an originating-side gas fee (commission) generated when originating-side SC are transferred on the originating-side blockchain, and a beneficiary-side gas fee generated when beneficiary-side SC are transferred on the beneficiary-side blockchain, and
in which the gas fee manager takes over the payment of the originating-side gas fee using a native token of the originating-side blockchain, and takes over the payment of the beneficiary-side gas fee using a native token of the beneficiary-side blockchain.

### ASPECT 12

The remittance system described in Aspect 11,

in which the blockchain management subsystem requests the payment of originating-side SC or originating-side legal tender corresponding to the originating-side gas fee from the originating-side integration subsystem or the originating financial institution system, and requests the payment of originating-side SC or originating-side legal tender corresponding to the beneficiary-side gas fee from the originating-side integration subsystem or the originating financial institution system.

### ASPECT 13

The remittance system described in Aspect 1,
in which the blockchain management subsystem, when receiving the remittance instruction from the originating-side integration subsystem via the SWIFT system, performs a contract for SC on the single blockchain to transfer the SC from an originating-side account to a beneficiary-side account.

### ASPECT 14

The remittance system described in Aspect 13,
in which the originating-side integration subsystem sends a request for acquiring a remittance status to the blockchain management subsystem via the SWIFT system.

### ASPECT 15

The remittance system described in Aspect 13,
in which the blockchain management subsystem includes a gas fee manager that processes a gas fee (commission) generated when SC are transferred on the single blockchain, and
in which the gas fee manager takes over the payment of the gas fee using a native token of the single blockchain.

### ASPECT 16

The remittance system described in Aspect 15,
in which the blockchain management subsystem requests the payment of SC or legal tender corresponding to the gas fee from the originating-side integration subsystem or the originating financial institution system.

### ASPECT 17

The remittance system described in Aspect 1,
in which the plurality of blockchains comprise an originating-side blockchain and a beneficiary-side blockchain, and
in which the blockchain management subsystem, when receiving the remittance instruction from the originating-side integration subsystem via the SWIFT system, burns (erases) originating-side SC on the originating-side blockchain and mints (newly issues) beneficiary-side SC on the beneficiary-side blockchain.

### Advantageous Effects of Invention

The remittance system according to the present invention enables an international remittance using SC by integration with the SWIFT system.

### BRIEF DESCRIPTION OF DRAWINGS

FIG. 1 is a conceptional diagram showing a remittance network including remittance systems according to first and second embodiments and the SWIFT system.

FIG. 2 is a block diagram showing a remittance system according to the first embodiment.

FIG. 3 is a block diagram showing a remittance system according to the second embodiment.

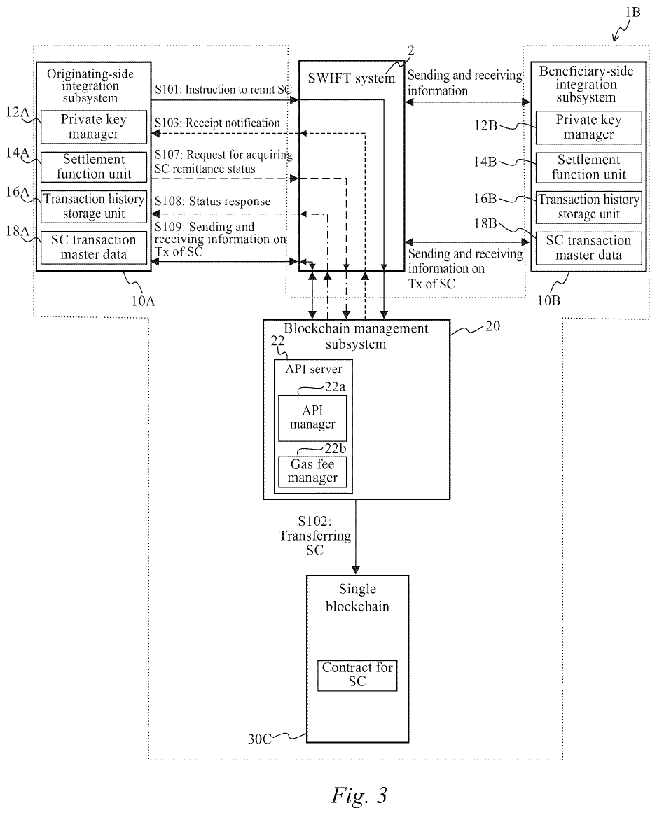

### DESCRIPTION OF EMBODIMENTS

Embodiments of the remittance system using SC according to the present invention are described with reference to the drawings. In the present embodiments, SC may be SC on the “Progmat coin” platform provided by Progmat, Inc., but platforms for SC and SC themselves are not limited thereto. For example, Ethereum, Cosmos, Avalanche or Polygon may be used as blockchains underlying SC. For example, USDT, USDC or JPYC may be used as SC.

First, terms used in the embodiments are described.

“Contract for liquidity” can be understood to be a place where a certain amount of SC is stored for the purpose of adjusting supply and demand (i.e., liquidity pool). On blockchains such as Ethereum and those similar thereto, an area called “contact account” can be formed on a blockchain. A token (SC in the present embodiments) may be kept in the contract account. Accordingly, a contract for liquidity is “a contract account having on a blockchain, SC as liquidity for adjusting supply and demand.”

“Contract for SC” is a contract (i.e., program) for creating, managing and transferring SC on a blockchain. A contract for SC is programmed in accordance with specific standards (i.e., ERC 20 compliant) and provides functions such as the issuance, proprietary right transfer and balance inquiry of SC. Accordingly, a contract for SC is a program provided on each blockchain and has functions for implementing the issuance, management and transfer of SC.

A contract for SC in the first embodiment includes a function of transfer. Using this function, on an originating-side blockchain, SC are transferred from the address of an originating-side account to the liquidity pool (SC are locked). Meanwhile, on a beneficiary-side blockchain, SC are transferred from the liquidity pool to the address of a beneficiary-side account (SC are unlocked).

“IBC (inter-blockchain communication)” is a universal interoperability protocol that enables both blockchains performing cross-chain to communicate with each other. LCP is a middleware that performs a light client verification for a beneficiary-side blockchain on behalf of an originating-side blockchain, and generates a proof that enables the originating-side blockchain to verify the validity of the beneficiary-side blockchain at a low cost. In the first embodiment, “IBC/LCP module” on the originating-side blockchain and “LCP/relayer” on the blockchain management subsystem are integrated with each other, and perform communication and data transfer between different blockchains (i.e., cross-chain).

The remittance systems according to the embodiments of the present invention are characterized by the features below:
Feature 1-1: The remittance system provides an originating-side subsystem for an originating financial institution; so that the originating-side subsystem is integrated with the existing SWIFT system (in other words, it sends and receives information to and from the existing SWIFT system), and the originating-side subsystem exchanges (sends and receives) information relating to a transaction (Tx) of SC to and from the SWIFT system.

Feature 1-2: The remittance system provides a subsystem for a beneficiary bank for integrating with the existing SWIFT system, and the subsystem for a beneficiary bank exchanges (sends and receives) information relating to Tx of SC to and from the SWIFT system.

In addition, the types of the remittance system 1 according to the embodiments of the present invention can be divided into a remittance system 1A according to the first embodiment and a remittance system 1B according to the second embodiment as described later, depending on the status of blockchains.

### Remittance Network Including Remittance System 1

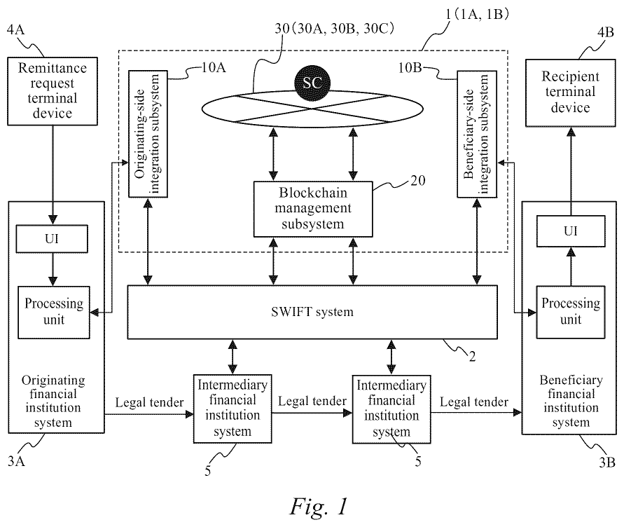

A remittance network including the remittance system 1 according to the first or second embodiment and the SWIFT system 2 is described with reference to FIG. 1. The remittance system 1 (1A, 1B) is integrated with the SWIFT system 2. An originating-side integration subsystem 10A is linked to an originating financial institution system 3A. In addition, a beneficiary-side integration subsystem 10B is linked to a beneficiary financial institution system 3B.

The remittance system 1 is composed of an originating-side integration subsystem 10A linked to the SWIFT system 2 so as to be integrated with the SWIFT system 2 on the originating side, the beneficiary-side integration subsystem 10B linked to the SWIFT system 2 so as to be integrated with the SWIFT system 2 on the beneficiary side, a blockchain management subsystem 20 linked to the originating-side integration subsystem 10A and/or the beneficiary-side integration subsystem 10B via the SWIFT system, and at least one blockchain 30 (30A, 30B, 30C) linked to the blockchain management subsystem 20.

As is obvious from FIG. 1, the remittance system 1 is directly linked to the SWIFT system 2, and the originating financial institution system 3A and the beneficiary financial institution system 3B are each linked to the remittance system 1 via the processing units thereof. Thus, a user of a remittance request terminal device 4A or of a recipient terminal device 4B can make an international remittance in the same conventional manner without changing a conventional user interface (UI). Here, FIG. 1 describes only one blockchain 30 but a plurality of blockchains 30A, 30B may also be applicable.

### First Embodiment (In the Case of a Cross-Chain)

The remittance system 1A according to the first embodiment is a case including a plurality of or different types of originating-side blockchain 30A and a beneficiary-side blockchain 30B.

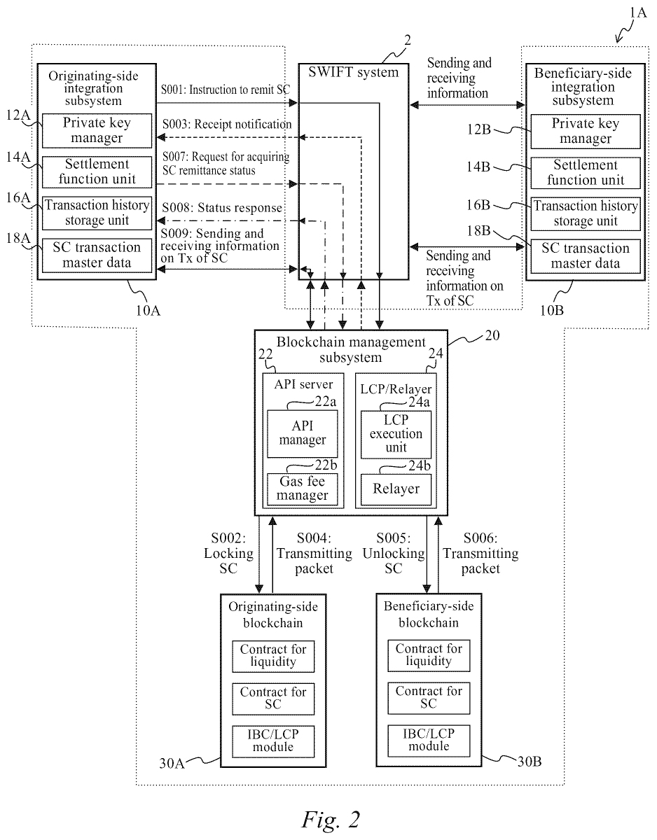

As shown in FIG. 2, the remittance system 1A is composed of the originating-side integration subsystem 10A, the blockchain management subsystem 20, the beneficiary-side integration subsystem 10B, the originating-side blockchain 30A and the beneficiary-side blockchain 30B.

The originating-side integration subsystem 10A has a private key manager 12A, a settlement function unit 14A that performs settlement processing, a transaction history storage unit 16A and SC transaction master data 18A. On the originating-side blockchain 30A, a contract for Liquidity and a contract for SC are performed. On the originating-side blockchain 30A, an IBC/LCP module function is performed.

The blockchain management subsystem 20 has an API (application programming interface) server 22 and an LCP/relayer 24. The API server 22 has an API manager 22a and a gas fee manager 22b.

The API manager 22a provides an API integration for sending and receiving data between the blockchain management subsystem 20 and the originating-side integration subsystem 10A via the SWIFT system 2.

The gas fee manager 22b is provided in order to process a commission generated when SC are mutually transferred via a plurality of or different blockchains. A gas fee on a blockchain is a transaction cost generated on the blockchain when an SC remittance is performed.

A gas fee must be paid using a native token of an underlying blockchain. For example, when an underlying blockchain is Ethereum, a gas fee must be paid in a native token ETH. Thus, gas fees in the first embodiment must be paid in a native token of the originating-side blockchain 30A and in a native token of the beneficiary-side blockchain 30B, respectively.

The blockchain management subsystem 20 holds an originating-side native token and a beneficiary-side native token in the gas fee manager 22b, and can take over the payment of an originating-side gas fee generated on the originating-side blockchain 30A and a beneficiary-side gas fee generated on the beneficiary-side blockchain 30B.

For the payment of an originating-side gas fee generated on the originating-side blockchain 30A, two payment methods 1 and 2 are mentioned as described below.
Payment method 1: receiving, in an originating-side native token, from the originating-side integration subsystem 10A. Specifically, the blockchain management subsystem 20 sends a request for payment, in an originating-side native token of the originating-side blockchain 30A, to the originating-side integration subsystem 10A, at a predetermined timing of a request for payment. The originating-side integration subsystem 10A that has received the request for payment pays an originating-side gas fee, in the native token of the originating-side blockchain 30A.
Payment method 2: receiving, in originating-side SC, from the originating-side integration subsystem 10A or receiving, in originating-side legal tender, from the originating-side financial institution system 3A. Specifically, the gas fee manager 22b pays an originating-side gas fee, in a native token of the originating-side blockchain 30A, and thereafter the blockchain management subsystem 20 performs predetermined processing to collect the originating-side gas fee from the originating-side integration subsystem 10A or the originating-side financial institution system 3A. The predetermined processing may be, but not limited to, for example, the following processing A1 or A2.
Processing A1: receiving the gas fee, in originating-side SC, from the originating-side integration subsystem 10A. Specifically, the blockchain management subsystem 20 sends a request for payment, in originating-side SC corresponding to an originating-side gas fee, to the originating-side integration subsystem 10A, at a predetermined timing of a request for payment. The originating-side integration subsystem 10A that has received the request for payment transfers the originating-side SC corresponding to the originating-side gas fee, from the SC wallet of the originating-side integration subsystem 10A to the SC wallet of the blockchain management subsystem 20.
Processing A2: receiving the gas fee, in legal tender (such as JPY or USD), from the originating-side financial institution system 3A. Specifically, the blockchain management subsystem 20 sends a request for payment of originating-side legal tender corresponding to an originating-side gas fee, to the originating-side financial institution system 3A, at a predetermined timing of a request for payment.

A beneficiary-side gas fee generated on the beneficiary-side blockchain 30B is paid by the gas fee manager 22b, in a native token of the beneficiary-side blockchain 30B, and thereafter the blockchain management subsystem 20 performs predetermined processing to collect the beneficiary-side gas fee from the originating-side integration subsystem 10A or the originating-side financial institution system 3A. The predetermined processing may be, but not limited to, for example, the following processing B1 or B2.
Processing B1: receiving the gas fee, in originating-side SC, from the originating-side integration subsystem 10A. Specifically, the blockchain management subsystem 20 sends a request for payment, in originating-side SC corresponding to a beneficiary-side gas fee, to the originating-side integration subsystem 10A, at a predetermined timing of a request for payment. The originating-side integration subsystem 10A that has received the request for payment transfers originating-side SC corresponding to the beneficiary-side gas fee, from the SC wallet of the originating-side integration subsystem 10A to the SC wallet of the blockchain management subsystem 20.
Processing B2: receiving the gas fee, in originating-side legal tender (such as JPY or USD), from the originating-side financial institution system 3A. Specifically, the blockchain management subsystem 20 sends a request for payment of originating-side legal tender corresponding to a beneficiary-side gas fee, to the originating-side financial institution system 3A, at a predetermined timing of a request for payment.

With respect to the above predetermined timing of a request for payment, the request may be sent to one originating financial institution, per one request for payment, per a predetermined number of requests for payment, or per a predetermined period.

The beneficiary-side integration subsystem 10B has a private key manager 12B, a settlement function unit 14B that performs settlement processing, a transaction history storage unit 16B and SC transaction master data 18B. On the beneficiary-side blockchain 30B, a contract for liquidity and a contract for SC are performed as smart contracts. On the beneficiary-side blockchain 30B, an IBC/LCP module function is performed.

On the originating-side blockchain 30A, a contract for liquidity is a contract of storing beforehand a predetermined amount of originating-side SC to secure liquidity. A contract for liquidity is necessary to ensure that, at the moment at which a specific remittance is performed, such a transaction is irreversible and final.

On the beneficiary-side blockchain 30B, a contract for liquidity is a contract of storing beforehand a predetermined amount of beneficiary-side SC to secure liquidity. A contract for liquidity is necessary to ensure that, at the moment at which a specific remittance is performed, such a transaction is irreversible and final.

With a contract for liquidity that provides liquidity, a predetermined amount of originating-side SC and a predetermined amount of beneficiary-side SC can be quickly transferred.

The LCP/relayer 24 is composed of an LCP execution unit 24 a that processes LCP (light client proxy) and a relayer 24b that mediates communication between blockchains. The LCP execution unit is a middleware provided by Datachain, Inc. that verifies the interoperability processing of blockchains. The LCP/relayer 24, integrated with an IBC/LCP module function on the originating-side blockchain 30A and the beneficiary-side blockchain 30B, performs SC cross-chain.

The LCP execution unit 24a supports IBC (inter-blockchain communication) as a standard protocol relating to communication between a plurality of or different blockchains. To mediate communication between the originating-side blockchain 30A and the beneficiary-side blockchain 30B, the relayer 24b requests (queries) a processing packet of originating-side SC on the originating-side blockchain 30A and transfers Tx to the beneficiary-side blockchain 30B.

The SC remittance system according to the first embodiment is characterized by the features below:
Feature 1-1: being capable of creating Tx information on originating-side SC in the originating-side integration subsystem 10A and sending the Tx information to the originating-side blockchain 30A via the SWIFT system 2 and the API server 22 of the blockchain management subsystem 20.

Feature 1-2: being capable of transferring originating-side SC from the originating-side account on the originating-side blockchain 30A to a contract for originating-side liquidity that is a liquidity pool, using a contract for SC.

Feature 1-3: in response to the detection of a packet for verifying the validity of a transaction or data as a trigger, the LCP/relayer 24 using a cross-chain technique can transfer beneficiary-side SC from the liquidity pool on the beneficiary-side blockchain 30B to a beneficiary-side account, using a contract for SC. The packet includes a proposal for a post-transaction status including a signature.

Feature 1-4: on the basis of the request by the originating-side integration subsystem 10A, the blockchain management subsystem 20 can notify the beneficiary-side integration subsystem 10B of the completion of the remittance of originating-side SC via the SWIFT system 2. Otherwise, even without the request by the originating-side integration subsystem 10A, the blockchain management subsystem 20 can recognize the completion of the remittance of originating-side SC based on Tx of the originating-side blockchain 30A, and notify the beneficiary-side integration subsystem 10B of the completion of the remittance of originating-side SC.

Next, with reference to FIG. 2, a flow of actual SC remittance processing in the remittance system 1A is described. The flow of processing described below relates to a case where the remittance system 1A performs a lock-unlock method (cf. S002: lock, S005: unlock). First, the remittance request terminal device 4A sends to the originating financial institution system 3A an instruction to remit a predetermined amount in a currency such as legal tender or originating-side SC. The originating financial institution system 3A sends the remittance instruction to the originating-side integration subsystem 10A.

In step S001, the originating-side integration subsystem 10A sends an instruction to remit originating-side SC to the API server of the blockchain management subsystem 20 via the SWIFT system 2. The instruction to remit originating-side SC may preferably be a Tx signed by a private key for verifying the validity of a telegraphic message for originating-side SC, in order to remit originating-side SC in an amount corresponding to a predetermined amount.

In step S001, when the API server 22 receives the instruction to remit originating-side SC via the API manager 22a, the gas fee manager 22b takes over the payment of a gas fee and then the flow proceeds to step S002.

In step S002, the blockchain management subsystem 20 sends, from the address of the management account, an instruction to lock originating-side SC corresponding to the amount of remittance. The instruction to lock originating-side SC is performed by a contract for liquidity and a contract for SC on the originating-side blockchain 30A.

By performing a contract for SC, originating-side SC corresponding to the amount of remittance are transferred from the address of the originating-side account on the originating-side blockchain 30A to the contract for liquidity as a liquidity pool. The liquidity of the originating-side SC is secured.

In step S003, the blockchain management subsystem 20 sends a notification of the receipt of the remittance instruction (i.e., Tx hash) to the originating-side integration subsystem 10A via the SWIFT system 2.

In step S004, the relayer 24b inside the blockchain management subsystem 20 detects a packet for verifying the validity of a transaction or data. The LCP execution unit 24a verifies a proof. The packet includes a proposal for a post-transaction status including a signature.

In step S005, the blockchain management subsystem 20 sends an instruction to unlock beneficiary-side SC to the beneficiary-side blockchain 30B. On the beneficiary-side blockchain 30B, the instruction to unlock beneficiary-side SC is performed by a contract for liquidity and a contract for SC, and beneficiary-side SC corresponding to the amount of remittance are transferred from the liquidity pool to the address of the beneficiary-side account.

In step S006, the relayer 24b inside the blockchain management subsystem 20 detects a packet for verifying the validity of a transaction or data. The LCP execution unit 24a verifies a proof. Thereby the remittance from originating-side SC to beneficiary-side SC is completed. The packet includes a proposal for a post-transaction status including a signature.

In step S007, the originating-side integration subsystem 10A sends a request for acquiring a status of the SC remittance, using a notification of the receipt of the remittance instruction (i.e., Tx hash) to the blockchain management subsystem 20 via the SWIFT system 2.

In step S008, the blockchain management subsystem 20 sends the status of the SC remittance (i.e., remittance under processing or remittance having been completed) to the originating-side integration subsystem 10A via the SWIFT system 2. In step S009, the originating-side integration subsystem 10A or the blockchain management subsystem 20 sends and receives SC information (such as information on Tx) to and from the SWIFT system 2. Preferably in step S009, the originating-side integration subsystem 10A or the blockchain management subsystem 20 sends the status of the SC remittance (i.e., remittance under processing or remittance having been completed) to the SWIFT system 2.

In step S010, the originating-side integration subsystem 10A notifies via the SWIFT system 2 the beneficiary-side integration subsystem 10B of the completion of the SC remittance.

### Variation of First Embodiment

With respect to the remittance system 1A according to the first embodiment, the case where the lock-unlock method is performed in a cross-chain SC transfer has been described, but the present invention is not limited thereto. For example, a remittance system 1A′ according to the present variation can also perform a burn-mint method instead of the lock-unlock method.

The points in which the remittance system 1A′ differs from the remittance system 1A are described. The remittance system 1A′ has neither a contract for liquidity on the originating-side blockchain 30A nor a contract for liquidity on the beneficiary-side blockchain 30B. The LCP/relayer 24 manages the burn of originating-side SC and the mint of beneficiary-side SC. The remittance system 1A′ has step S002′ and step S005′ below instead of step S002 and step S005 in the remittance system 1A.

In step S002′, the blockchain management subsystem 20 sends an instruction to burn (i.e., to erase) originating-side SC to the originating-side blockchain 30A. In accordance with the instruction to burn originating-side SC, originating-side SC corresponding to the amount of remittance are burnt from the address of the originating-side account of the originating-side blockchain 30A, by a contract for SC.

In step S005′, the blockchain management subsystem 20 sends an instruction to mint (i.e., to newly issue) beneficiary-side SC to the beneficiary-side blockchain 30B. In accordance with the instruction to mint beneficiary-side SC, beneficiary-side SC corresponding to the amount of remittance are minted on the beneficiary-side account of the beneficiary-side blockchain 30B, by a contract for SC.

### Second Embodiment (In the Case of a Single Chain)

The remittance system 1B according to the second embodiment is a case where the originating-side and beneficiary-side blockchains are the same (i.e., a case of a single blockchain 30C). The same numerical references are assigned to the same portions as those included in the first embodiment and the descriptions thereof are omitted. In the second embodiment, the gas fee manager 22b is provided in order to process a commission (i.e., native token) generated when SC are transferred on the single blockchain 30C.

For the payment of a gas fee generated on the single blockchain 30C, two payment methods 1 and 2 are mentioned as described below.
Payment method 1: the originating-side integration subsystem 10A pays a gas fee, in a native token of the single blockchain 30C.
Payment method 2: the gas fee manager 22b pays a gas fee, in a native token of the single blockchain 30C, and thereafter the blockchain management subsystem 20 performs predetermined processing to collect the gas fee from the originating-side integration subsystem 10A or the originating-side financial institution system 3A. The predetermined processing may be, but not limited to, for example, the following processing C1 or C2.
Processing C1: receiving the gas fee, in SC, from the originating-side integration subsystem 10A. Specifically, the blockchain management subsystem 20 sends to the originating-side integration subsystem 10A a request for transferring SC (i.e., request for payment) in an amount corresponding to the originating-side gas fee. In response to the request, SC corresponding to the originating-side gas fee are transferred from the SC wallet of the originating-side integration subsystem 10A to the SC wallet of the blockchain management subsystem 20.
Processing C2: receiving the gas fee, in legal tender (such as JPY or USD), from the originating-side financial institution system 3A. Specifically, the blockchain management subsystem 20 sends to the originating-side financial institution system 3A a request for payment of legal tender in an amount corresponding to the gas fee.

In step S101, the originating-side integration subsystem 10A sends an instruction to remit originating-side SC to the API server of the blockchain management subsystem 20 via the SWIFT system 2. The instruction to remit originating-side SC may preferably be Tx signed by a private key in order to transfer originating-side SC in an amount corresponding to a predetermined amount. The private key manager 12A generates Tx signed by a private key.

In step S102, the blockchain management subsystem 20 sends, from the management address thereof, an instruction to transfer SC. The instruction to transfer SC is performed by a contract for SC on a single blockchain 30C.

By performing the contract for SC, originating-side SC in an amount corresponding to the amount of the remittance are transferred from the address of the originating-side account to the address of the beneficiary-side account, on the single blockchain 30C.

In step S103, the blockchain management subsystem 20 sends a notification of the receipt of the remittance instruction (i.e., Tx hash) to the originating-side integration subsystem 10A via the SWIFT system 2.

In step S107, the originating-side integration subsystem 10A sends a request for acquiring a status of the SC remittance to the blockchain management subsystem 20 via the SWIFT system 2 using a notification of the receipt of the remittance instruction (i.e., Tx hash).

In step S108, the blockchain management subsystem 20 sends the status of the SC remittance (i.e., remittance under processing or remittance having been completed) to the originating-side integration subsystem 10A via the SWIFT system 2.

In step S109, the originating-side integration subsystem 10A or the blockchain management subsystem 20 sends and receives SC information (such as information on Tx) to and from the SWIFT system 2. In step S109, the originating-side integration subsystem 10A or the blockchain management subsystem 20 preferably sends the status of the SC remittance (i.e., remittance under processing or remittance having been completed) to the SWIFT system 2.

In step S110, the originating-side integration subsystem 10A notifies via the SWIFT system 2 the beneficiary-side integration subsystem 10B of the completion of the SC remittance.

The remittance system 1B according to the second embodiment is characterized by the features below:
Feature 2-1: being capable of creating Tx information relating to SC, which is sent from the originating-side integration subsystem 10A to the single blockchain 30C, via the SWIFT system 2 and the API server.

Feature 2-2: being capable of remitting SC from the address of the originating-side account to the address of the beneficiary-side account, on the single blockchain 30C.

Feature 2-3: on the basis of a request by the originating-side integration subsystem 10A, the blockchain management subsystem 20 can notify the beneficiary-side integration subsystem 10B of the completion of the originating-side SC remittance, via the SWIFT system 2.

Finally, mechanical elements included in the above remittance system 1 (1A, 1B) are described. The originating-side integration subsystem 10A and the beneficiary-side integration subsystem 10B may be an originating-side integration server (computer) and a beneficiary-side integration server (computer), respectively. The blockchain management subsystem 20 includes an API server (computer) and a server for LCP/relayer (computer). The blockchain management subsystem 20 may have a blockchain management server (computer) instead of the API server (computer) and the server for LCP/relayer (computer). The blockchain management server may have an API execution unit and an LCP/relayer.

These servers may have one or more central processing units (CPU), memory such as a random access memory (RAM), storage devices such as a hard disc drive (HDD) and/or a solid state drive (SSD), communication devices such as a router for communicating with other servers, and power sources for supplying electricity to the above. The originating-side integration server and the beneficiary-side integration server each have a computer program for operating, for example, a private key manager and a settlement function unit; and information such as that in a transaction history storage unit and SC transaction master data is stored in the storage device. The server for the blockchain management subsystem may have a computer program for operating an API manager, a gas fee manager, an LCP execution unit, and a relayer. The server for the blockchain management subsystem may have a computer program for operating a contract for liquidity, a contract for SC and an IBC/LCP module. Each of these servers may be a physical server, a virtual server or a cloud server.

### REFERENCE SIGNS LIST

1 SC remittance system
1A SC remittance system (cross-blockchain type)
1B SC remittance system (single blockchain type)
2 SWIFT system
10A Originating-side integration subsystem
10B Beneficiary-side integration subsystem
20 Blockchain management subsystem
30A Originating-side blockchain
30B Beneficiary-side blockchain
30C Single blockchain

1. A remittance system for performing an international remittance using stablecoins (SC) by integration with a SWIFT system linked to a financial institution system, said remittance system comprising:
an originating-side integration subsystem linked to an originating-side financial institution system of a remitter;
a beneficiary-side integration subsystem linked to a beneficiary-side financial institution system of a recipient;
a blockchain management subsystem linked to the originating-side integration subsystem and the beneficiary-side integration subsystem via the SWIFT system; and
a plurality of blockchains or a single blockchain linked to the blockchain management subsystem,
wherein the blockchain management subsystem and the originating-side integration subsystem are configured to transmit information relating to an SC transfer on the plurality of blockchains or the single blockchain to the SWIFT system.

2. The remittance system according to claim 1,
wherein the information relating to the SC transfer is information relating to a transaction (Tx) of SC.

3. The remittance system according to claim 1,
wherein the originating-side integration subsystem sends a remittance instruction to the blockchain management subsystem via the SWIFT system.

4. The remittance system according to claim 3,
wherein the remittance instruction is a transaction (Tx) signed by a private key of the originating-side integration subsystem or the blockchain management subsystem.

5. The remittance system according to claim 1,
wherein the plurality of blockchains comprise an originating-side blockchain and a beneficiary-side blockchain, and
wherein the blockchain management subsystem, when receiving the remittance instruction from the originating-side integration subsystem via the SWIFT system, locks originating-side SC on the originating-side blockchain and unlocks beneficiary-side SC on the beneficiary-side blockchain.

6. The remittance system according to claim 5,
wherein due to locking of the originating-side SC, the originating-side SC are transferred on the originating-side blockchain from an originating-side account to a liquidity pool, and
wherein due to unlocking of the beneficiary-side SC, the beneficiary-side SC are transferred on the beneficiary-side blockchain from the liquidity pool to a beneficiary-side account.

7. The remittance system according to claim 6,
wherein the blockchain management subsystem detects and verifies a packet for verifying the validity of a transaction or data relating to the lock of the originating-side SC on the originating-side blockchain, and detects and verifies a packet for verifying the validity of a transaction or data relating to the unlock of the beneficiary-side SC on the beneficiary-side blockchain.

8. The remittance system according to claim 7,
wherein the originating-side integration subsystem sends a request for acquiring a remittance status to the blockchain management subsystem via the SWIFT system.

9. The remittance system according to claim 8,
wherein the blockchain management subsystem, when receiving the request for acquiring a remittance status, sends the remittance status based on the approval of the lock of the originating-side SC and the approval of the unlock of the beneficiary-side SC to the originating-side integration subsystem via the SWIFT system.

10. The remittance system according to claim 1,
wherein the originating-side integration subsystem sends via the SWIFT system the completion of the SC remittance to the beneficiary-side integration subsystem.

11. The remittance system according to claim 1,
wherein the plurality of blockchains comprise an originating-side blockchain and a beneficiary-side blockchain,
wherein the blockchain management subsystem comprises a gas fee manager that processes an originating-side gas fee (commission) generated when originating-side SC are transferred on the originating-side blockchain, and a beneficiary-side gas fee generated when beneficiary-side SC are transferred on the beneficiary-side blockchain, and
wherein the gas fee manager takes over the payment of the originating-side gas fee using a native token of the originating-side blockchain, and takes over the payment of the beneficiary-side gas fee using a native token of the beneficiary-side blockchain.

12. The remittance system according to claim 11,
wherein the blockchain management subsystem requests the payment of originating-side SC or originating-side legal tender corresponding to the originating-side gas fee from the originating-side integration subsystem or the originating financial institution system, and requests the payment of originating-side SC or originating-side legal tender corresponding to the beneficiary-side gas fee from the originating-side integration subsystem or the originating financial institution system.

13. The remittance system according to claim 1,
wherein the blockchain management subsystem, when receiving the remittance instruction from the originating-side integration subsystem via the SWIFT system, performs a contract for SC on the single blockchain to transfer the SC from an originating-side account to a beneficiary-side account.

14. The remittance system according to claim 13,
wherein the originating-side integration subsystem sends a request for acquiring a remittance status to the blockchain management subsystem via the SWIFT system.

15. The remittance system according to claim 13,
wherein the blockchain management subsystem comprises a gas fee manager that processes a gas fee (commission) generated when SC are transferred on the single blockchain, and
wherein the gas fee manager takes over the payment of the gas fee using a native token of the single blockchain.

16. The remittance system according to claim 15,
wherein the blockchain management subsystem requests the payment of SC or legal tender corresponding to the gas fee from the originating-side integration subsystem or the originating financial institution system.

17. The remittance system according to claim 1,
wherein the plurality of blockchains comprise an originating-side blockchain and a beneficiary-side blockchain, and
wherein the blockchain management subsystem, when receiving the remittance instruction from the originating-side integration subsystem via the SWIFT system, burns (erases) originating-side SC on the originating-side blockchain and mints (newly issues) beneficiary-side SC on the beneficiary-side blockchain.
